(19) United States
(12) Patent Application Publication
(10) Pub. No.: US 2026/0318721 A1
(43) Pub. Date: Oct. 15, 2026

(54) NON-FIRING TOOLMARK REPRODUCTION SYSTEMS, METHODS, AND CONSUMABLE PAYLOADS FOR FIREARM EXAMINATION

(71) Applicants: Ryan Lilien, Wilmette, IL (US); Zachary Carr, Lawrence, KS (US); Eric Meschke, Chicago, IL (US); Roland Meijer, Pepperell, MA (US)

(72) Inventors: Ryan Lilien, Wilmette, IL (US); Zachary Carr, Lawrence, KS (US); Eric Meschke, Chicago, IL (US); Roland Meijer, Pepperell, MA (US)

(21) Appl. No.: 19/545,033

(22) Filed: Feb. 20, 2026

Related U.S. Application Data
(60) Provisional application No. 63/761,809, filed on Feb. 21, 2025.

(51) Int. Cl. G01D 11/00; F41A 31/02

(52) U.S. Cl. CPC G01D 11/00; F41A 31/02

(57) ABSTRACT

Systems, methods, and consumable payloads are provided for reproducing rifling-origin toolmarks on a projectile surrogate without firing a firearm. An elongated drive member is positioned generally coaxially with a rifled bore, and a deformable payload configured to receive striated toolmarks is advanced through the bore using controlled mechanical motion. In some embodiments, a capture module mounted at a barrel end includes an aperture, a bearing assembly, and an alignment feature that react axial load while permitting rotation of the drive member and maintaining coaxial alignment. In some embodiments, the payload includes an anti-binding architecture including a marking portion configured to engage rifling and a drive portion configured to couple to the drive member while reducing binding. Recovered payloads bearing toolmarks may be examined using forensic microscopy and related techniques.

### FIELD OF THE INVENTION

The present disclosure relates to forensic firearm and toolmark examination and, more particularly, to non-firing systems, methods, and consumable payloads configured to reproduce rifling-origin striated toolmarks on a projectile surrogate advanced through a firearm barrel in a controlled manner.

### BACKGROUND

Firearm and toolmark examination is a forensic discipline in which microscopic marks imparted onto bullets and cartridge cases are examined to assess whether they originated from a particular firearm. In general, a rifled firearm barrel includes helical rifling features such as lands and grooves. When a projectile traverses the rifled bore, the projectile can be engraved and can carry impressed and/or striated marks corresponding to microscopic characteristics of the bore surface and its manufacturing and wear history.

Common laboratory practice to obtain known comparison specimens is to test fire a firearm and recover bullets and/or cartridge cases (for example, using bullet recovery devices such as water tanks or cotton/soft recovery systems) so that recovered test bullets can be compared to questioned bullets. However, test firing may be undesirable or impractical in some circumstances, such as where the firearm is damaged, unsafe to fire, lacks required parts, is evidentiary or delicate, is subject to administrative or legal restrictions, or where a laboratory seeks to reduce time, logistics, or cost associated with test firing and projectile recovery.

Various non-firing approaches have been used or proposed. For example, casting materials can reproduce certain impressed marks on cartridge cases or firearm components. In addition, practitioners may “slug” a barrel by pushing a soft slug through the bore to observe bore characteristics and/or to generate a specimen. However, traditional methods for pushed or forced slugs can be inconsistent, can be difficult to perform repeatably, and can inadvertently smear, overwrite, or destroy fine striated toolmarks if the slug experiences discontinuous motion, uncontrolled deformation, uncontrolled torque, or misalignment relative to the bore axis.

Accordingly, there remains a need for robust non-firing systems and methods that can generate high-quality projectile surrogate specimens bearing rifling-origin striated toolmarks, with improved repeatability and reduced risk of toolmark damage, while also being adaptable to different firearm types and conditions.

### SUMMARY

In one aspect, the present disclosure provides a non-firing toolmark reproduction system comprising: (i) an elongated drive member configured to extend along at least a portion of a firearm bore; (ii) a drive mechanism configured to advance the drive member and/or a payload in a controlled manner without explosive propulsion; (iii) a deformable payload configured to traverse the bore and to receive rifling-origin striated toolmarks; and (iv) optionally, a mounting fixture configured to stabilize a firearm, a barreled action, a barrel, or another firearm component during operation.

In another aspect, the present disclosure provides a capture and alignment module mountable at or near a muzzle end and/or a breech end of a barrel. The module can include an aperture for the drive member, a bearing assembly (e.g., a thrust bearing) configured to react axial loads while permitting rotation of a portion of the drive member, and one or more alignment features (e.g., bushings, inserts, centering washers, or sleeves) configured to maintain coaxial alignment of the drive member with the bore axis while a payload traverses the bore.

In another aspect, the present disclosure provides consumable payload architectures configured to reduce binding and improve toolmark fidelity. In some embodiments, a payload comprises (i) a marking portion having an outer diameter selected to engage rifling and to record striated toolmarks, and (ii) a drive portion configured to couple to a drive member while reducing the likelihood that bore-induced compression clamps the payload onto the drive member. For example, the marking portion may define a clearance bore larger than a drive member diameter, while the drive portion may define a threaded bore portion for engagement with a threaded drive member, and the drive portion outer diameter may be smaller than a bore diameter so that the drive portion is not substantially compressed by the bore.

In another aspect, the present disclosure provides multi-part payload stacks, including a threaded driver and a non-threaded passenger payload separated by a deformation-inducing element (e.g., a ferrule). Such configurations can decouple thread engagement from the primary marking surface and can apply outward radial forces to promote rifling engagement and toolmark capture.

In another aspect, the present disclosure provides methods of non-firing reproduction of rifling-origin toolmarks by advancing a payload through a bore using controlled mechanical motion (e.g., continuous rotation or controlled linear actuation), while permitting the payload to rotate as guided by the rifling and capturing the payload after traversal for microscopic comparison.

### BRIEF DESCRIPTION OF THE DRAWINGS

The accompanying drawings illustrate example embodiments of the invention and, together with the description, serve to explain principles of the invention. The drawings are not necessarily to scale; emphasis is instead placed upon illustrating principles of the invention. Like reference numerals refer to like elements throughout the drawings.

FIG. 1 is a schematic cross-sectional view of an example locknut-driven non-firing toolmark reproduction configuration in which an elongated drive member extends through a barrel and advances a payload via a drive nut and optional deformation-inducing element.

FIG. 2 is a schematic cross-sectional view of an example threaded-payload configuration in which a payload includes a marking portion and a drive portion having different inner and/or outer diameters to reduce binding and to improve controlled traversal through a bore.

FIG. 3 is a schematic cross-sectional view of an example configuration including a threaded driver, a deformation-inducing element, and a passenger payload advanced through a bore.

FIG. 4 is a perspective view of an example assembly including a barrel secured in a fixture and a capture module positioned at an end of the barrel.

FIG. 5 is a perspective view of an example insertion configuration including a protective interface (e.g., an O-ring and a removable plastic guide or polymer sleeve) during insertion of the elongated drive member through the bore. The protective interface can reduce scraping, marring, and off-axis insertion of the elongated drive member relative to the bore.

FIG. 6 is a perspective view of an example attachment of a payload to an elongated drive member prior to advancement through the bore. In this example, after removal of the plastic guide used during insertion, the payload is loaded onto the elongated drive member. In some embodiments, an additional protective interface (e.g., a second O-ring, guide sleeve, or wiper) can be positioned behind the payload during advancement.

FIG. 7 is a perspective view of an example operation in which a drive mechanism (e.g., drill) rotationally drives an elongated drive member to advance a payload into a capture module.

FIG. 8 is a perspective view of an example bearing/alignment stack used to support and align the elongated drive member relative to a capture module.

### DETAILED DESCRIPTION

The present disclosure is described more fully below with reference to the accompanying drawings, in which illustrative embodiments are shown. This disclosure may, however, be embodied in many different forms and should not be construed as limited to the embodiments set forth herein. Rather, these embodiments are provided so that this disclosure will satisfy applicable legal requirements and will convey the scope of the invention to those skilled in the art.

Unless otherwise defined, all technical and scientific terms used herein have the same meaning as commonly understood by one of ordinary skill in the art. The terminology used in the description is for the purpose of describing particular embodiments only and is not intended to be limiting.

### Definitions and Interpretation

As used herein, the term “firearm” includes handguns, rifles, shotguns, and other devices that include a barrel and that are configured to launch a projectile, whether assembled, disassembled, operable, inoperable, complete, or incomplete. The term also encompasses a barreled action, an upper receiver assembly, a barrel assembly, a barrel removed from a firearm, and other firearm components that include a rifled bore.

As used herein, the term “bore” refers to an internal passage of a barrel through which a projectile may travel. A rifled bore can include lands and grooves (including conventional rifling) or other rifling geometries such as polygonal rifling. The term “bore axis” refers to a central longitudinal axis of the bore.

As used herein, the terms “payload,” “slug,” and “projectile surrogate” refer to a body configured to traverse a bore and to receive rifling-origin striated toolmarks. A payload can be consumable and can be configured for microscopic comparison after extraction. Because surrogates are made of a solid material it can serve as an archival marking of the barrel. That is, the surrogate can be stored for later analysis

As used herein, the term “non-firing” means without using explosive combustion (e.g., gunpowder) or other energetic propellant to propel the payload through the barrel. Non-firing systems described herein can advance a payload through controlled mechanical motion such as rotary-to-linear translation, linear actuation, hydraulic actuation, pneumatic actuation, or combinations thereof.

As used herein, the term “controlled motion” includes continuous motion, substantially continuous motion, incremental motion, or feedback-controlled motion that avoids repeated impact blows and that reduces jerks that may smear toolmarks. Controlled motion may be manual or powered and may include motion control features such as speed control, torque limiting, clutching, or sensing.

As used herein, the phrase “rifling-guided rotation” means that, as the payload advances axially through the bore, the payload is permitted (and in some embodiments forced by the helical rifling geometry) to rotate about the bore axis in a manner consistent with engagement of the payload surface with the rifling features. The systems herein are configured to avoid forcing a payload to translate axially through rifling without rotation, which may overwrite or smear striated toolmarks.

As used herein, the term “interference fit” refers to a fit in which an outer diameter of a payload region is larger than a corresponding inner diameter (e.g., land-to-land diameter and/or groove-to-groove diameter) of a bore region such that the payload undergoes plastic and/or elastic deformation upon insertion and traversal. Interference fit can be selected to ensure rifling engagement and toolmark capture.

As used herein, the term “about” means within a tolerance that is reasonable in view of the context, including manufacturing tolerance, measurement error, and/or variability attributable to materials and operating conditions. In some embodiments, “about” can mean within ±10% of a stated value, within ±5% of a stated value, within ±1% of a stated value, or another tolerance that is appropriate for the context.

As used herein, the term “toolmarks” includes striated marks, impressed marks, microscopic scratches, and other surface features imparted by contact and relative motion between a payload and an interior surface of a barrel.

As used herein, the term “elongated drive member” refers to a member configured to transmit axial force to advance a payload through a bore, including a threaded rod, lead screw, ball screw, roller screw, push rod, pull rod, cable, strap, rack, chain, belt, and/or an output member of a linear actuator.

As used herein, the term “translation member” refers to a component that converts actuation of the elongated drive member into axial advancement of a payload, including a traveling nut, locknut, carriage, driver body, driver slug, threaded portion of a payload, or other rotary-to-linear or linear-to-linear converter.

As used herein, the term “capture module” (also referred to as a collection box, catch box, or capture fixture) refers to a structure positioned at or near an end of a barrel and configured to (i) maintain coaxial alignment of the elongated drive member with the bore axis, (ii) react axial loads during advancement, and/or (iii) capture an exiting payload to preserve toolmarks.

As used herein, the term “deformation-inducing element” (also referred to as an expander or ferrule) refers to an element configured to apply outward radial force to a payload directly or indirectly (e.g., by converting axial force to radial expansion), thereby promoting rifling engagement and toolmark capture.

As used herein, the term “free-rotation assembly” or “torque-decoupling interface” refers to a bearing, bushing, washer stack, spherical seat, or other interface configured to transmit axial load while permitting relative rotation, thereby reducing parasitic torsion on a payload and reducing toolmark smear.

### Figure-by-Figure Description

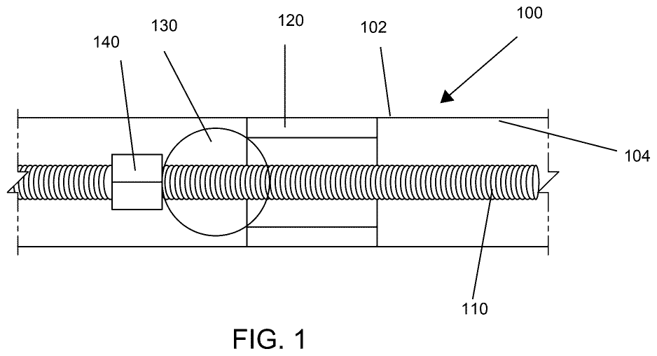

### FIG. 1

FIG. 1 is a schematic cross-sectional view of an example locknut-driven non-firing toolmark reproduction configuration. In the illustrated embodiment, a barrel 102 defines a bore 104 having rifling 106. An elongated drive member 110 extends generally coaxially through the bore 104 and can include a threaded portion 112 and, in some embodiments, an unthreaded portion 114 positioned to reduce thread contact with interior barrel surfaces. A payload 120 is positioned in the bore 104 and configured to engage rifling 106 to record striated toolmarks during advancement. In this configuration, the payload 120 can define a clearance bore sized to receive the elongated drive member 110 without threaded engagement, and axial load for advancing the payload 120 is applied by a drive nut 140 positioned on the threaded portion 112 of the elongated drive member 110. In some embodiments, a free-rotation assembly 150 is positioned between the drive nut 140 and the payload 120 to transmit axial load while permitting relative rotation, thereby reducing torsional coupling between the elongated drive member 110 and the payload 120. In some embodiments, a deformation-inducing element 130 (also referred to as an expander or ferrule) is positioned between the drive nut 140 and the payload 120 such that axial compression produces outward radial deformation of at least a portion of the payload 120 to promote consistent rifling engagement. An arrow indicates an example direction of advancement of the payload 120 toward an exit end of the barrel 102.

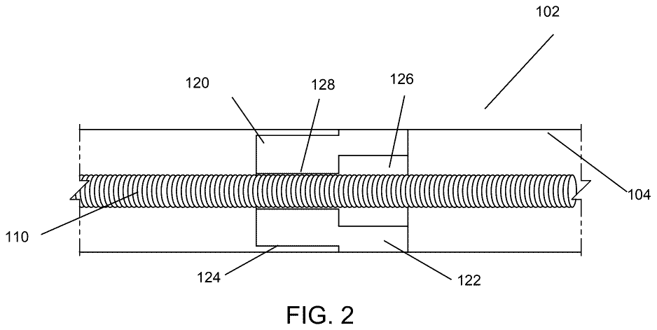

### FIG. 2

FIG. 2 is a schematic cross-sectional view of an example threaded-payload configuration. A barrel 102 defines a bore 104 having rifling 106. An elongated drive member 110 includes a threaded portion 112 that engages a threaded bore portion 128 of a payload 120. The payload 120 includes a marking portion 122 configured to engage rifling 106 and a drive portion 124 configured to couple to the elongated drive member 110. In some embodiments, the marking portion 122 defines a clearance bore 126 that is larger than an outer diameter of the elongated drive member 110 such that, even as the marking portion 122 is engraved and/or compressed by rifling engagement, the marking portion 122 does not clamp onto the elongated drive member 110. In some embodiments, the drive portion 124 has an outer diameter smaller than the bore 104, thereby reducing contact between the drive portion 124 and the bore 104 and reducing binding at the threaded engagement between the threaded bore portion 128 and the threaded portion 112. Relative rotation between the elongated drive member 110 and the threaded bore portion 128 converts rotation into controlled axial advancement of the payload 120 while permitting the payload 120 to rotate as guided by rifling 106. An arrow indicates an example direction of advancement through the bore 104.

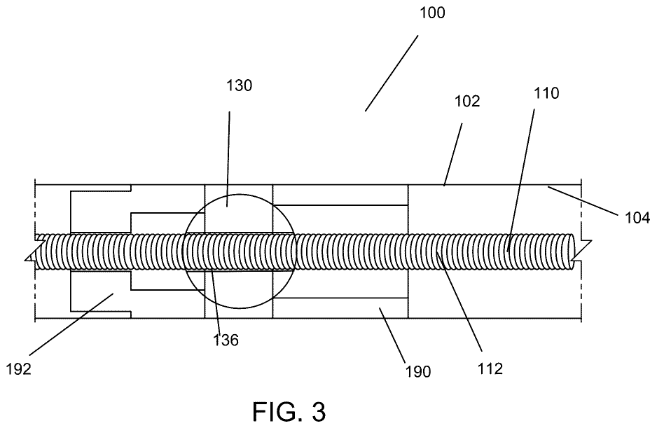

### FIG. 3

FIG. 3 is a schematic cross-sectional view of an example configuration including a threaded driver 192, a deformation-inducing element 130, and a passenger payload 190 advanced through a bore 104. A barrel 102 defines a bore 104 having rifling 106. An elongated drive member 110 includes a threaded portion 112 engaged by the threaded driver 192. The threaded driver 192 transmits axial load to the deformation-inducing element 130 positioned between the threaded driver 192 and the passenger payload 190. In some embodiments, the deformation-inducing element 130 includes a tapered and/or spherical interface and defines a through-bore 136 permitting passage of the elongated drive member 110. As axial load is applied, the deformation-inducing element 130 can be pressed into the passenger payload 190 to create outward radial deformation and promote rifling engagement. In some embodiments, one or both of the threaded driver 192 and passenger payload 190 can record toolmarks during traversal of the bore 104.

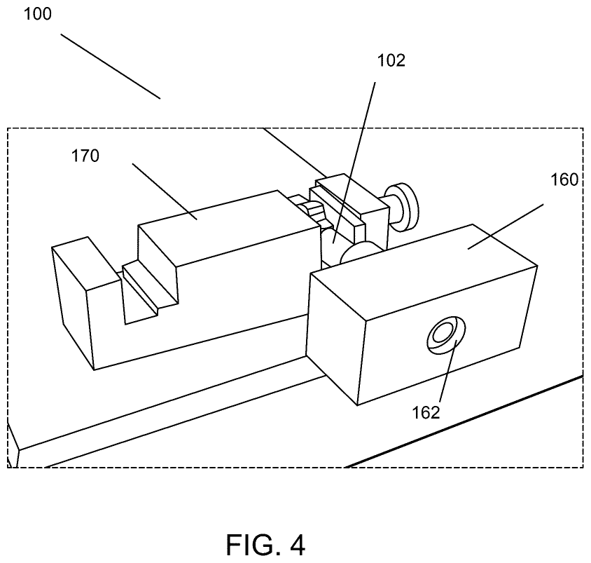

### FIG. 4

FIG. 4 is a perspective view of an example assembly of a non-firing toolmark reproduction system 100 in which a barrel 102 is secured in a fixture 170 and a capture module 160 is positioned adjacent an end (e.g., a muzzle end) of the barrel 102. The fixture 170 can maintain the barrel 102 in a stable, repeatable orientation and can support alignment of the capture module 160 with an axis of the barrel 102. The capture module 160 can define an internal capture volume and, in some embodiments, can include cushioning, containment, and/or evidence-handling features to receive and protect an extracted payload after the payload exits the barrel 102.

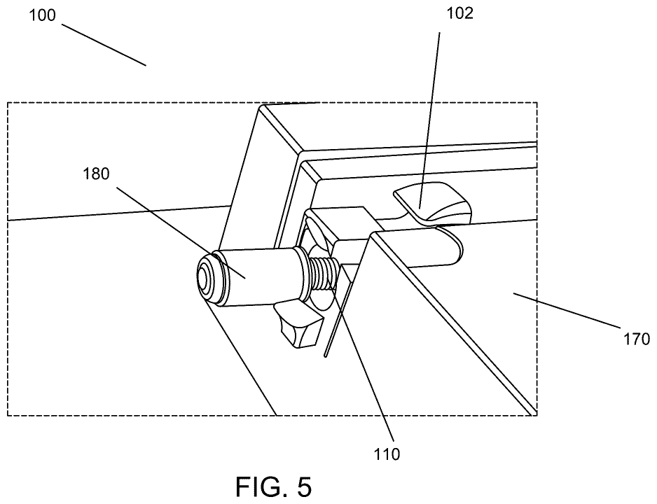

### FIG. 5

FIG. 5 is a perspective view of an example insertion configuration including a protective interface 180 during insertion of an elongated drive member 110 into a bore 104 of a barrel 102. In some embodiments, an insertion guide 180 includes a polymer sleeve 184 and/or an elastomeric O-ring 182 positioned at or near a breech end of the barrel 102 to center the elongated drive member 110, reduce canting, and reduce the risk of scraping or damaging the bore 104 during insertion. The protective interface 180 may be removable and/or replaceable, and may be configured as a caliber-specific guide in some embodiments.

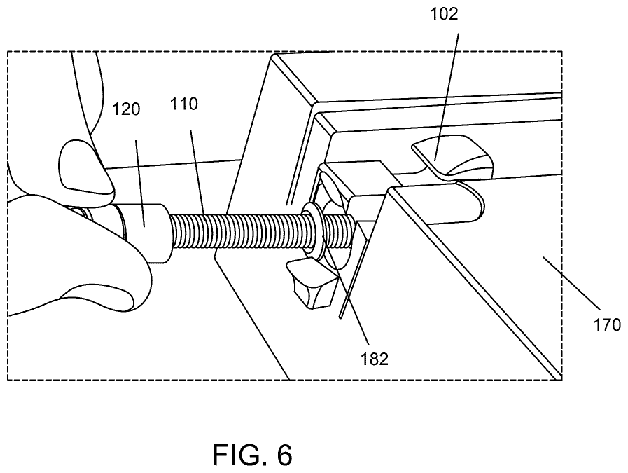

### FIG. 6

FIG. 6 is a perspective view of an example attachment of a payload 120 to an elongated drive member 110 prior to advancement through the bore 104 of a barrel 102. In the illustrated embodiment, the payload 120 is positioned at an entrance end of the bore 104 and is coupled to the elongated drive member 110 for subsequent controlled advancement. An O-ring 182 can be positioned proximate the barrel 102 and/or behind the payload 120 to provide centering, sealing, wiping, and/or protection of interior surfaces during handling and advancement.

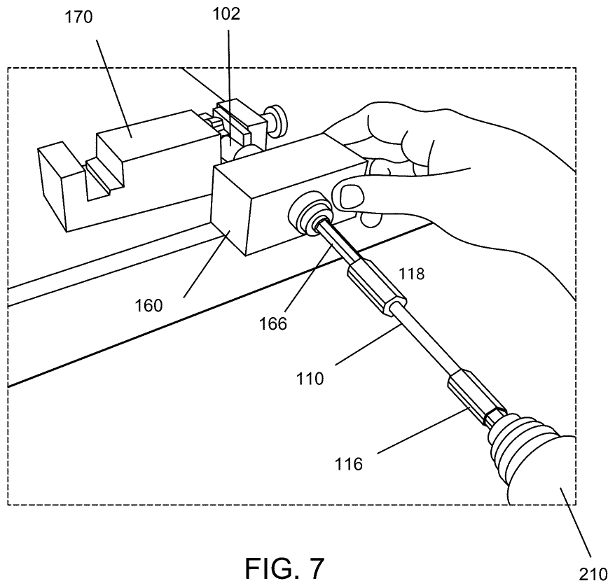

### FIG. 7

FIG. 7 is a perspective view of an example operation in which a drive mechanism 210 (e.g., a drill, motor, hand crank, or other actuator) rotationally drives an elongated drive member 110 to advance a payload 120 through a barrel 102 and into a capture module 160. In some embodiments, the drive mechanism 210 couples to a drive interface 116 at a proximal end of the elongated drive member 110. In some embodiments, a protective sleeve 118 is disposed on at least a portion of the elongated drive member 110 to reduce abrasion of interior barrel surfaces. In some embodiments, a sensor 200 is provided to measure one or more operational parameters such as torque, rotation rate, axial load, displacement, or a combination thereof during advancement.

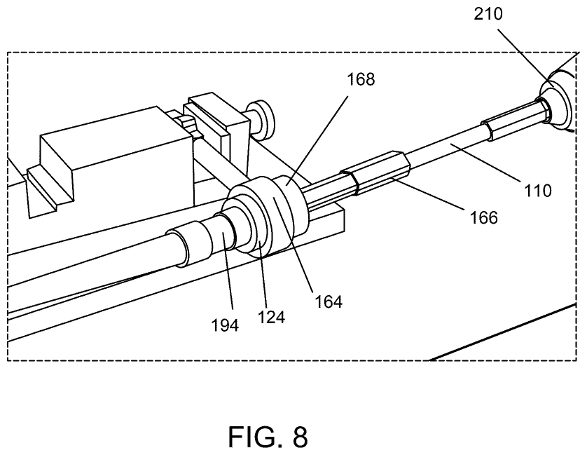

### FIG. 8

FIG. 8 is a perspective view of an example bearing and alignment stack associated with a capture module 160. In the illustrated embodiment, the elongated drive member 110 passes through an aperture 162 of the capture module 160. A bearing assembly 164 (e.g., a thrust bearing or other axial-load-reacting bearing) can support axial load while permitting relative rotation between the elongated drive member 110 and the capture module 160. One or more jam nuts 166 can be tightened on the elongated drive member 110 to axially locate and, in some embodiments, preload the bearing assembly 164. One or more alignment inserts 168 (e.g., a stepped polymer insert) can center the elongated drive member 110 relative to the aperture 162 and thereby improve coaxial alignment between the elongated drive member 110 and the bore axis. In some embodiments, a spring element 194 and/or other compliant element maintains engagement between stack components and reduces looseness during rotation.

### System Overview

FIGS. 1-8 illustrate example embodiments of non-firing toolmark reproduction systems 100 configured to generate rifling-origin striated toolmarks on one or more payloads 120 without test firing. In general, the systems 100 can include one or more of: a barrel 102 defining a bore 104 with rifling 106; an elongated drive member 110 configured to extend along at least a portion of the bore 104; one or more payloads 120 configured to traverse the bore 104 and to receive toolmarks; a drive mechanism 210 configured to provide controlled motion; a capture module 160 configured to receive an extracted payload; and a fixture 170 configured to stabilize at least one component during operation.

In use, the elongated drive member 110 is positioned generally coaxially with the bore axis. A payload 120 is coupled to the elongated drive member 110 directly or indirectly (e.g., via a drive nut, a threaded engagement, a driver-payload stack, or other coupling). The drive mechanism 210 applies controlled motion to advance the payload 120 through the bore 104. The payload 120 engages the rifling 106 and receives striated toolmarks on an external surface. The payload 120 can be captured and retained for subsequent forensic comparison microscopy or other imaging and analysis.

The disclosure herein includes individual components (e.g., payload geometries, capture modules, alignment stacks) as well as collective systems and methods. Unless expressly stated otherwise, any feature described in connection with any embodiment may be combined with any feature described in connection with other embodiments, where such combination is feasible.

### Elongated Drive Member and Drive Mechanism

The elongated drive member 110 can comprise a threaded rod (lead screw), an Acme screw, a ball screw, a roller screw, a multi-start screw, a partially threaded shaft, a shaft with a threaded portion 112 and an unthreaded portion 114, a cable or strap, a pushrod, a pull rod, a rack, or any other structure capable of transmitting controlled axial forces sufficient to move a payload through the bore.

In some embodiments, the elongated drive member 110 includes a proximal drive interface 116 (e.g., hex shank, square drive, chuck interface, keyway, spline, or socket) configured to couple to a manual or powered drive mechanism 210. The drive mechanism 210 can be a hand crank, ratchet, wrench, drill, driver, motor, gearmotor, stepper motor, servo motor, linear actuator, hydraulic cylinder, pneumatic cylinder, or combinations thereof.

In some embodiments, the drive mechanism 210 is configured to rotate the elongated drive member 110 while an axial reaction feature constrains the elongated drive member 110 from translating relative to a capture module 160, thereby converting relative rotation between the elongated drive member 110 and a threaded payload 120 into controlled axial advance of the payload. In other embodiments, the drive mechanism 210 is configured to translate the elongated drive member 110 axially (with or without rotation) to advance a payload through the bore.

In some embodiments, the drive mechanism 210 is configured to provide a substantially constant rotation rate or translation rate to reduce jerk and toolmark smear. In some embodiments, the drive mechanism 210 is configured to provide incremental motion (e.g., stepwise advancement) with controlled dwell periods. In some embodiments, the drive mechanism 210 includes or is associated with a torque limiter, slip clutch, electronic current limit, or other feature configured to reduce the risk of excessive load application that could damage a barrel or a payload.

In some embodiments, the elongated drive member 110 has an outer diameter selected for stiffness and clearance, for example about 2 mm to about 20 mm, about 3 mm to about 12 mm, or about 4 mm to about 10 mm, depending on caliber and barrel length. In some embodiments, the elongated drive member includes a thread pitch selected to provide a desired advance rate, for example about 0.25 mm/turn to about 10 mm/turn (metric) or about 4 to about 40 threads-per-inch. These ranges are non-limiting examples and can be varied based on desired force, speed, and payload material.

In some embodiments, the elongated drive member 110 is configured to be inserted from a breech end toward a muzzle end, or from a muzzle end toward a breech end, and may protrude from one or both ends of the barrel during operation. In some embodiments, the elongated drive member includes end stops or travel limits to avoid over-travel.

### Capture, Alignment, and Reaction Module

In some embodiments, a capture module 160 (also referred to as a collection box or slug catch box) is mounted at or near an end of the barrel 102, such as a muzzle end. The capture module 160 can define an internal capture volume configured to receive an extracted payload 120 after traversal through the bore 104, and can define an aperture 162 configured to allow passage of the elongated drive member 110.

In some embodiments, the capture module 160 is mounted by a clamp, set screws, a split collar, muzzle threads, a bayonet-type interface, a friction fit, an O-ring seal, an elastomeric sleeve, or other mount. In some embodiments, the capture module 160 includes interchangeable adapters configured to fit different barrel outer diameters and/or muzzle thread patterns.

In some embodiments, the capture module 160 includes a bearing assembly 164 (e.g., a thrust bearing, angular contact bearing, ball bearing, roller bearing, needle bearing, bushing, or combinations thereof) configured to support the elongated drive member 110 and to react axial loads during advancement of the payload 120 while permitting rotation of at least a portion of the elongated drive member 110. In some embodiments, the bearing assembly 164 reduces frictional resistance that would otherwise be transmitted to the drive mechanism 210 and/or to the fixture 170, thereby enabling smoother advancement and improved toolmark fidelity.

In some embodiments, the capture module 160 includes one or more alignment features 168 such as a bushing, stepped insert, sleeve, washer stack, centering ring, bore pilot, or compliant centering member configured to maintain coaxial alignment of the elongated drive member 110 with the bore axis. For example, an alignment insert 168 may define a stepped bore with a smaller diameter region configured to guide the elongated drive member 110 and a larger diameter region configured to receive portions of a bearing assembly 164 and/or fastening hardware.

In some embodiments, the capture module 160 includes one or more nuts, jam nuts, or lock nuts 166 positioned on the elongated drive member 110 to axially locate the elongated drive member 110 relative to the capture module 160 and to preload a bearing assembly 164. In some embodiments, the capture module 160 includes a spring element 194, compliant element, or elastomeric member configured to maintain alignment, reduce vibration, and/or absorb shock as the payload 120 enters the capture volume.

In some embodiments, the capture volume of the capture module 160 includes a cushioning medium such as foam, polymer gel, elastomer, water, oil, cotton, fiber, or a replaceable liner configured to reduce secondary damage to toolmarks when a payload exits the barrel. In some embodiments, the capture module 160 includes a removable tray, cup, sealed capsule, or liner to facilitate evidence handling and to reduce cross-contamination between tests.

### Mounting Fixture and Protective Interfaces

In some embodiments, a mounting fixture 170 stabilizes a firearm, barrel, or component during operation. The fixture 170 can be a barrel vise, bench vise, clamp, cradle, tripod mount, portable field clamp, or other support configured to prevent gross movement and to maintain alignment of the barrel 102 and capture module 160. In some embodiments, the fixture 170 includes compliant jaws or inserts configured to reduce marring of the barrel exterior.

In some embodiments, one or more protective interfaces 180 are provided to reduce the risk of scraping or damaging the bore 104 by the elongated drive member 110 during insertion. For example, as shown in FIG. 5, an insertion guide 180 can include a polymer guide sleeve 184 (also referred to as a plastic guide) and/or an elastomeric O-ring 182 configured to center the elongated drive member 110 relative to the bore and/or to protect the bore surface during insertion. In some embodiments, the polymer guide sleeve 184 is removed prior to attaching a payload to the elongated drive member 110 (FIG. 6). In some embodiments, one or more additional O-rings, bushings, guide sleeves, or wipers are placed behind the payload during advancement to provide centering and/or protection.

In some embodiments, the elongated drive member 110 includes a protective sleeve 118 (e.g., polymer coating, heat-shrink tubing, PTFE sleeve, UHMW sleeve) on at least a portion thereof configured to reduce abrasion of the bore 104. In some embodiments, the protective sleeve 118 is removable or replaceable.

In some embodiments, the system includes a bore pilot at the muzzle and/or breech configured to guide the elongated drive member and reduce canting. In some embodiments, the bore pilot is caliber-specific and is formed from polymer, brass, or other material less likely than steel to mar a barrel interior.

### Payload Architectures

The payload 120 is configured to engage the rifling 106 and to record rifling-origin striated toolmarks on an external surface. The payload 120 can be formed from a material softer than barrel steel so that the rifling engraves the payload surface. Suitable materials can include, by way of example and not limitation, copper, brass, aluminum, lead, lead alloys, bismuth alloys, tin alloys, zinc alloys, polymers, waxes, composites, layered constructions, and combinations thereof.

In some embodiments, the payload 120 includes a marking portion 122 configured to contact the bore 104 and a drive portion 124 configured to couple to the elongated drive member 110. The marking portion 122 can have an outer diameter selected to provide an interference fit with at least the lands and/or grooves of the rifling 106. The drive portion 124 can have an outer diameter smaller than the bore diameter so that the drive portion 124 does not substantially contact the bore 104, thereby reducing friction, reducing compression of the drive portion 124, and reducing the likelihood that the drive portion clamps onto the elongated drive member 110.

In some embodiments, the marking portion 122 defines a clearance bore 126 having an inner diameter larger than an outer diameter of the elongated drive member 110, thereby reducing or eliminating contact between the marking portion 122 and the elongated drive member 110. This clearance can be beneficial (and in some materials and geometries can be critical) because the marking portion 122 may be radially compressed by rifling engagement during traversal, and such compression could otherwise reduce the marking portion inner diameter and clamp onto the elongated drive member 110. By providing the clearance bore 126, the marking portion 122 can deform to record toolmarks while avoiding binding against the elongated drive member 110.

In some embodiments, the drive portion 124 defines a threaded bore portion 128 (e.g., a tapped hole) configured to engage a threaded portion 112 of the elongated drive member 110. In some embodiments, the threaded bore portion 128 is positioned in a region of the payload 120 that is not substantially compressed by the bore 104, thereby reducing the risk of thread deformation, galling, or binding. In some embodiments, the payload 120 comprises at least two different inner diameters (e.g., a clearance bore 126 at the marking portion 122 and a smaller threaded bore portion 128 at the drive portion 124) and/or at least two different outer diameters (e.g., an interference outer diameter at the marking portion 122 and a clearance outer diameter at the drive portion 124).

In some embodiments, the payload marking portion 122 has an interference fit relative to the bore. By way of non-limiting examples, the marking portion outer diameter may be about 0.0001 inch to about 0.020 inch larger than a corresponding bore diameter (land-to-land and/or groove-to-groove), depending on payload material hardness, lubrication, and desired engraving depth. In some embodiments, a smaller interference is used for softer payloads, and a larger interference is used for harder payloads. The present disclosure is not limited to a particular interference value.

In some embodiments, the payload 120 includes one or more features that facilitate evidence handling and repeatability, such as a handling flange, extraction groove, ID marking, serial identifier, or a flat surface for labeling. In some embodiments, the payload 120 includes a sacrificial outer layer or coating (e.g., polymer coating, thin metallic layer, plated layer) configured to capture fine striations and to be protected during handling. In some embodiments, the sacrificial layer is removable or peelable after traversal to expose and preserve an engraved surface.

In some embodiments, payloads can assume different shapes, including cylindrical slugs, ogive or truncated-cone profiles, and payloads with one or more driving bands. In some embodiments, payloads include reduced bearing surface regions to reduce friction while maintaining sufficient contact to capture toolmarks. In some embodiments, the payload includes a chamfered or radiused leading edge to facilitate entry into the bore and to reduce shaving.

In some embodiments, payloads are manufactured by machining, casting, molding, swaging, additive manufacturing, or combinations thereof. In some embodiments, payloads are provided pre-cleaned and individually packaged as consumables.

### Deformation-Inducing Elements

In some embodiments, the system includes a deformation-inducing element 130 configured to apply an outward radial component of force to a payload 120 during advancement through the bore 104. The deformation-inducing element 130 can include, by way of example, a ferrule, a tapered insert, a conical wedge, a spherical element, a segmented collet, a split sleeve, an expandable ring, or other geometry that converts axial load into radial expansion of at least a portion of the payload 120.

In some embodiments, the deformation-inducing element 130 defines a through-bore 136 permitting passage of the elongated drive member 110. In some embodiments, the deformation-inducing element 130 is positioned between a driver and a passenger payload (FIG. 3) or between a drive nut and a payload (FIG. 1) such that axial advancement compresses the deformation-inducing element into a payload to create outward radial deformation.

In some embodiments, the deformation-inducing element 130 is configured to simulate aspects of firing-induced obturation or engraving by promoting consistent rifling engagement. However, the present disclosure does not require replicating all conditions of live firing (e.g., propellant gas dynamics), and instead focuses on controlled mechanical advancement that produces usable striated toolmarks.

### Torque-Decoupling and Free-Rotation Assemblies

In some embodiments, the system includes a free-rotation assembly 150 configured to decouple rotation of the elongated drive member 110 from a payload 120 and/or from a drive nut 140, thereby reducing the risk that externally imposed torsion overrides rifling-guided rotation. The free-rotation assembly 150 can include a thrust bearing, a needle bearing, a bushing, a low-friction washer stack, an angular contact bearing, or other structure configured to transmit axial load while permitting relative rotation between adjacent components.

In some embodiments, torque-decoupling features are also provided at the capture module 160 (e.g., via thrust bearing 164 and alignment insert 168) so that rotation of the elongated drive member 110 does not require the fixture 170 to resist significant torsional load, thereby enabling smoother, more consistent advancement of the payload.

### Embodiment 1: Locknut-Driven Payload Advancement (FIG. 1)

FIG. 1 illustrates an embodiment in which a payload 120 (e.g., a passenger slug) defines a clearance bore sized to receive the elongated drive member 110 without thread engagement. A drive nut 140 (e.g., a locknut) is positioned on the elongated drive member 110 behind the payload 120. Upon advancement of the drive nut 140 relative to the elongated drive member 110, the drive nut 140 exerts an axial force on the payload 120, thereby advancing the payload through the bore 104.

In some embodiments, advancement of the drive nut 140 is achieved by rotating the drive nut 140 relative to a rotationally constrained elongated drive member 110. In some embodiments, advancement of the drive nut 140 is achieved by rotating the elongated drive member 110 while constraining the drive nut 140 against rotation (e.g., within a guide block, keyed housing, anti-rotation rail, or flats-and-slot constraint). In some embodiments, the drive nut 140 is captured within a housing that prevents rotation and allows translation as the elongated drive member 110 rotates.

In some embodiments, a free-rotation assembly 150 is positioned between the drive nut 140 and the payload 120 to permit the elongated drive member 110 and/or the drive nut 140 to rotate while transmitting axial force to the payload 120. In some embodiments, the free-rotation assembly 150 includes a thrust bearing configured to reduce friction at the interface and to reduce the likelihood of toolmark smear due to torsional drag. By reducing sliding friction at an axial load interface, the thrust bearing can reduce input torque demanded of the drive mechanism 210 (e.g., a drill) and can reduce torsional reaction otherwise borne by the fixture 170 and operator.

In some embodiments, a deformation-inducing element 130 (e.g., a tapered or spherical ferrule with a through-bore) is positioned between the drive nut 140 and the payload 120 such that axial compression causes outward radial deformation of at least a portion of the payload 120. The outward radial deformation can improve rifling engagement and can promote consistent toolmark capture.

### Embodiment 2: Threaded Payload With Anti-Binding Geometry (FIG. 2)

FIG. 2 illustrates an embodiment in which the payload 120 includes a threaded bore portion 128 configured to engage a threaded portion 112 of the elongated drive member 110. The payload 120 includes a marking portion 122 having an outer diameter selected to engage rifling 106 and to receive toolmarks. The payload 120 further includes a drive portion 124 having an outer diameter smaller than the bore 104, such that the drive portion 124 has reduced or no contact with the bore during traversal.

In some embodiments, the marking portion 122 defines a clearance bore 126 that is larger than the elongated drive member 110. As the marking portion 122 is engraved and/or compressed by the rifling 106, the clearance bore 126 helps prevent the marking portion 122 from clamping onto the elongated drive member 110 as it is deformed/compressed during the toolmark transfer process. In some embodiments, the threaded bore portion 128 is located within the drive portion 124, which is not substantially compressed by the bore and therefore maintains reliable thread engagement with reduced binding risk.

In some embodiments, the elongated drive member 110 is rotated by a drive mechanism 210 while being axially reacted and aligned by a capture module 160 (e.g., FIG. 8). Relative rotation between the elongated drive member 110 and the payload 120 at the threaded engagement converts rotation into controlled axial advancement of the payload 120. Meanwhile, because the payload 120 engages rifling 106, the payload 120 is permitted to rotate as guided by the rifling while it advances. In some embodiments, the payload rotational speed induced by rifling engagement is different from the elongated drive member rotational speed, such that the threaded engagement experiences relative rotation sufficient to drive axial advancement while still permitting rifling-guided rotation of the payload.

In some embodiments, to further reduce risk of overriding rifling-guided rotation, the system includes one or more torque-decoupling features such as free-rotation assembly 150 and/or bearing assembly 164 at the capture module 160. In some embodiments, the drive mechanism 210 includes a clutch or torque limiter to prevent excessive loads if the payload encounters an obstruction or excessive friction.

### Embodiment 3: Threaded Driver, Deformation-Inducing Element, and Passenger Payload (FIG. 3)

FIG. 3 illustrates an embodiment comprising a threaded driver 192 configured to engage the threaded portion 112 of the elongated drive member 110, a passenger payload 190 having a clearance bore for the elongated drive member 110, and a deformation-inducing element 130 positioned between the driver 192 and the passenger payload 190. In some embodiments, the driver 192 is formed from copper or another engravable metal and includes a tapped core; the passenger payload 190 can be formed from a bismuth/tin alloy, copper, lead, or another engravable material with a through-bore. The driver 192 can include a marking portion configured to engage the rifling and/or can be configured primarily to transmit axial force.

In operation, the driver 192 advances along the elongated drive member 110 and transmits axial load to the deformation-inducing element 130 and passenger payload 190. The deformation-inducing element 130 can press into the passenger payload 190, producing outward radial deformation that promotes rifling engagement. The passenger payload 190 traverses the bore and records toolmarks. In some embodiments, both the driver 192 and the passenger payload 190 record toolmarks, thereby providing redundant specimens and allowing an examiner to select the specimen with superior mark quality for a given barrel condition and payload material.

In some embodiments, the driver 192 uses the anti-binding geometry described above (e.g., two outer diameters and two inner diameters) to reduce binding risk at the threaded engagement. In some embodiments, the passenger payload 190 uses a simplified clearance bore architecture to avoid thread artifacts on the primary marking surface.

### Example Capture Module and Bearing/Alignment Stack (FIGS. 4, 7, and 8)

FIG. 4 illustrates an example assembly in which a barrel 102 is secured by a fixture 170 and a capture module 160 is positioned adjacent a muzzle end of the barrel. FIG. 7 illustrates an example operation in which a drill or other drive mechanism 210 rotationally drives the elongated drive member 110 to advance a payload through the bore and into the capture module 160.

FIG. 8 illustrates an example bearing/alignment stack. In some embodiments, the elongated drive member 110 passes through an aperture 162 in the capture module 160 and is supported by a thrust bearing 164. One or more jam nuts 166 (e.g., hex nuts) can be tightened on the elongated drive member 110 to axially locate and optionally preload the thrust bearing 164. One or more alignment inserts 168 and/or washers can center the elongated drive member 110 relative to the aperture 162 and therefore relative to the bore axis. In some embodiments, the alignment insert 168 comprises a stepped Delrin (acetal) insert configured to seat within and align to the capture module aperture, and the stack can include a washer sized to align with the capture module and/or insert. In some embodiments, a Delrin bearing and spring and/or other compliant element 194 may be used to maintain contact, reduce looseness, and reduce rattle during rotation. The illustrated configuration is non-limiting, and any arrangement that provides axial reaction, rotational freedom, and coaxial alignment may be used.

### Methods of Use

The present disclosure also provides methods of generating one or more toolmark specimens without firing. In one example method, a firearm or barrel 102 is secured in a fixture 170 (e.g., a barrel vise). The elongated drive member 110 is inserted through the bore 104 (FIG. 5), optionally using an insertion guide 180 and protective interface such as an O-ring 182 and removable polymer guide sleeve/plastic guide 184. The polymer guide sleeve/plastic guide 184 can be removed before attaching a payload. A capture module 160 is positioned adjacent an end of the barrel 102 (FIG. 4). A payload 120 is coupled to the elongated drive member 110 (FIG. 6) and positioned at an entrance of the bore 104. In some embodiments, an additional O-ring, guide sleeve, or wiper is positioned behind the payload during advancement.

A drive mechanism 210 is then operated to advance the payload 120 through the bore 104 using controlled mechanical motion (e.g., substantially continuous rotation of the elongated drive member 110 and threaded advancement of a payload or driver). During advancement, the payload 120 is permitted to rotate in a manner consistent with rifling guidance, rather than being forced axially without rotation. The payload 120 exits the barrel and is captured by the capture module 160 (FIG. 7). The payload 120 can then be removed and preserved for microscopic comparison.

In some embodiments, the method includes generating multiple specimens by advancing multiple payloads sequentially through the bore. In some embodiments, the method includes adjusting payload size, material, lubrication, drive speed, or deformation-inducing elements to optimize toolmark quality for a given barrel condition. In some embodiments, the method includes reversing the drive mechanism to withdraw a payload if excessive resistance is detected.

In some embodiments, the method includes evidence-handling steps such as labeling and packaging extracted payloads, capturing images, and associating extracted payloads with a firearm identifier and case identifier. Such steps can be performed consistent with laboratory policies and procedures.

In some embodiments, the method includes verifying that a firearm is unloaded and safe to handle prior to use, and may include cleaning or inspecting the bore to ensure there is no obstruction. Such steps can be performed consistent with laboratory and safety policies.

### Best Mode/Example Operational Sequence (Non-Limiting)

An example operational sequence is described with reference to FIGS. 4-8. This sequence is illustrative and may be varied without departing from the scope of the disclosure.
Step 1: Stabilize the barrel using a fixture (e.g., vise, clamp, barrel block, or other stabilization fixturing).
Step 2: Insert the elongated drive member through the bore along the barrel axis, optionally using a protective guide sleeve and/or O-ring to protect the bore during insertion and to promote coaxial alignment.
Step 3: Position and secure a capture module (collection box/catch box) at or near a barrel end (e.g., muzzle end), and assemble a bearing/alignment stack to support the drive member while maintaining coaxial alignment and reacting axial loads (e.g., using a thrust bearing, washers, jam nuts, and/or an alignment insert).
Step 4: Remove or reposition the protective guide as appropriate, and install or confirm any centering and/or protective interfaces at the barrel end(s) and/or on the drive member (e.g., polymer sleeves, bushings, O-rings).
Step 5: Couple a selected payload assembly to the drive member (e.g., attach a threaded driver, position a clearance-bore passenger slug, and optionally place a deformation-inducing element between a thrust element and the payload).
Step 6: Couple a drive mechanism (e.g., drill, motor, linear actuator, or hand crank) to the drive member.
Step 7: Actuate the drive mechanism to advance the payload through the bore by controlled motion while permitting rifling-guided rotation; optionally monitor torque and/or axial force to detect binding and to avoid abrupt motion.
Step 8: Capture the payload in the capture module and remove the payload (preferably by designated non-engraved handling regions) for examination, imaging, and/or packaging.
Step 9: Optionally advance additional payloads sequentially (e.g., to generate multiple specimens and/or a driver and passenger specimen) and document/log the parameters associated with each specimen.

### Optional Parameter Selection and Repeatability Features

In some embodiments, advancement parameters are selected to promote repeatability of toolmarks, including selection of: payload material; payload interference; expander geometry; lubrication (if any); advancement speed; and torque/force limits. In some embodiments, the system records one or more parameters (e.g., via sensors or operator logs) to support consistent reproduction across multiple specimens and/or multiple laboratories.

In some embodiments, the system includes a calibration mode in which a test payload is advanced under controlled conditions to establish a baseline for a given barrel, after which a specimen payload is advanced using the same or adjusted conditions.

### Safety and Evidence-Handling Considerations

In some embodiments, the method includes verifying that the firearm is unloaded and that no live cartridge is present prior to operation. In some embodiments, the method includes preventing contact with an engraved region during retrieval, such as by using a collection fixture liner and handling the payload only at a designated non-engraved region.

In some embodiments, the method includes packaging the recovered specimen in a protective container that reduces abrasion of the engraved surface and preserves chain-of-custody documentation.

### Evidence Integrity, Packaging, and Chain-of-Custody

In forensic practice, the value of a specimen payload is often concentrated on the engraved surface region that contacted the barrel interior (e.g., land engraved areas, groove engraved areas, polygonal flats/edges, and associated microscopic striations). Accordingly, in some embodiments the disclosed system, kit, and/or method includes structures and procedures configured to reduce or prevent alteration, contamination, deformation, abrasion, and/or incidental marking of the specimen payload after extraction and during preservation, transport, storage, and/or examination.

In some embodiments, the payload assembly includes a designated handling region that is configured to be gripped without contacting an engraved band. By way of example and without limitation, the payload may include: (i) an unengraved nose region; (ii) an unengraved base region; (iii) a reduced-diameter trailing shank; (iv) a flattened or faceted handling portion; (v) a threaded stub; (vi) an internal-threaded drive portion; and/or (vii) a removable cap or sleeve that covers an engraved region during handling.

In some embodiments, the method includes handling the payload using clean gloves and/or clean tools (e.g., polymer-tipped forceps or a polymer pusher) and avoiding contact between hard metal tools and the engraved surface. In some embodiments, the method includes avoiding rubbing or sliding contact across the engraved region and instead lifting the specimen free from the collection fixture using a support surface or cradle. In some embodiments, the collection fixture includes an internal liner (e.g., polymer, elastomer, foam, fabric, or paper) configured to reduce impact and abrasion as the payload exits the barrel and enters the collection fixture.

In some embodiments, the method includes documenting the conditions under which the specimen was generated, including: firearm or barrel identification information; barrel length; caliber; rifling type; direction of advancement (breech-to-muzzle or muzzle-to-breech); payload material(s); payload geometry; lubricant type (if any); drive mechanism type; and advancement parameters (e.g., speed, torque limit, axial force limit, and/or number of rotations). Such documentation can be used to improve repeatability and to assist with later interpretation and/or comparison of the reproduced toolmarks.

In some embodiments, the method includes packaging each extracted specimen payload in an individual container configured to immobilize the specimen and protect engraved regions from contact with the container walls and from contact with other specimens. Non-limiting examples of individual containers include: a rigid pillbox or specimen box with a foam insert; a rigid plastic vial with an internal sleeve; a clamshell container; a compartmented evidence box; and/or a padded envelope containing a rigid internal container. In some embodiments, the container includes a recessed cavity or cradle sized to support the specimen by non-engraved regions. In some embodiments, the container includes a removable inner tray to facilitate removal without touching engraved bands.

In some embodiments, the method includes sealing the specimen container (e.g., with tamper-evident tape or a tamper-evident seal), labeling the container with a unique identifier, and maintaining chain-of-custody documentation identifying transfers of possession. In some embodiments, the system or kit includes pre-printed labels, barcodes, QR codes, and/or a digital logging interface for associating specimen identifiers with generated parameter logs and/or examiner notes. In some embodiments, multiple specimens produced from a single barrel are packaged separately and are identified with serial numbering (e.g., Specimen 1, Specimen 2, Specimen 3) corresponding to the order of production and/or parameter changes.

Non-limiting evidence-integrity features and/or handling steps include:
immobilizing the specimen within a container such that engraved regions do not contact hard surfaces during transport;
providing a designated non-marked handling region on the payload;
using a collection fixture with a soft liner and/or internal cavity sized to avoid scraping the engraved band;
recording and associating advancement parameters with the specimen identifier;
separating multiple specimens from one another and avoiding bulk packaging; and
sealing, labeling, and documenting transfers of the specimen to preserve chain-of-custody.

### EXEMPLARY WORKING EXAMPLES

The following examples are provided to illustrate non-limiting implementations of the disclosed systems and methods. The examples are intended to be exemplary and do not limit the scope of the disclosure. Dimensions, materials, and operating parameters may be varied depending on firearm type, caliber, rifling geometry, barrel condition, and laboratory protocols.

### Example 1: Conventional Rifled Handgun Barrel (Breech-to-Muzzle Pulling)

A conventionally rifled handgun barrel is secured in a barrel holding fixture such that the bore axis is stabilized. A muzzle-end collection fixture is positioned at the muzzle end of the barrel and aligned with the bore axis.

An elongated drive member (e.g., a threaded rod) is inserted through the bore from the breech end toward the muzzle end. During insertion, a protective guide and/or O-ring may be used to reduce contact between the drive member and the barrel interior.

A payload assembly is coupled to the drive member. In one non-limiting implementation, a threaded driver is engaged to the drive member, followed by an expander and a passenger payload having a clearance bore. The passenger payload is sized to plastically engage the rifling so that it rotates in response to rifling engagement while advancing through the bore.

A drive mechanism (e.g., a handheld drill, motor, or manual crank) is coupled to the drive member. The drive mechanism is actuated to provide controlled continuous advancement. In some implementations, a torque-limiting clutch and/or a constant-speed setting is used to reduce stick-slip motion and to preserve microscopic striations.

The payload exits the muzzle and is captured in the collection fixture. The specimen payload is removed by handling only a designated non-engraved region and is packaged in an individual container configured to protect engraved regions. The specimen is then available for comparison microscopy and/or digital/3D examination.

### Example 2: Polygonal Rifled Barrel With Radial Expansion Assistance

A barrel having polygonal rifling geometry is stabilized in a barrel holding fixture. A collection fixture is positioned at the muzzle end, and the drive member is inserted through the bore.

A passenger payload is selected having a material and outer diameter configured to conform to polygonal flats/edges when advanced. In some implementations, a deformation-inducing element (e.g., a spherical or conical ferrule/expander) is positioned to apply outward radial force to the passenger payload as axial force is transmitted from a driver.

The drive member is advanced using controlled continuous motion. The passenger payload is advanced through the bore while rotating in response to the rifling geometry. Radial expansion provided by the expander increases consistent contact with the polygonal profile and can improve the fidelity of reproduced toolmarks.

Upon capture, the resulting specimen payload is preserved and packaged individually, with documentation of barrel type and parameters. Multiple specimens may be generated using different expander geometries and/or different payload materials to identify the conditions yielding the most useful toolmarks for comparison.

### Example 3: Unsafe-to-Fire or Damaged Firearm/Isolated Barrel Component

A firearm or barrel that is unsuitable for live firing (e.g., due to damage, uncertain mechanical integrity, or safety policy restrictions) is examined and stabilized in a fixture. In some implementations, the barrel is removed from the firearm and secured as an isolated component; in other implementations, the assembled firearm is secured in a manner that provides access to the bore from an entry end.

A drive member is inserted through the bore. A payload assembly is selected to reduce risk of binding (e.g., a payload having an anti-binding marking portion with a clearance bore, a reduced-diameter drive portion, and/or a driver/passenger architecture). A low-friction bearing stack at the collection fixture may be used to reduce required drive torque and thereby reduce the likelihood of sudden motion.

The payload is advanced using a conservative parameter set (e.g., low speed and torque limiting) to reduce the chance of abrupt movement in a damaged or obstructed bore. If resistance increases beyond a threshold, the procedure may be paused, reversed, and/or repeated using an alternate payload geometry or material.

After extraction, each specimen is packaged individually and labeled as a non-firing reproduced toolmark specimen associated with the specific firearm/barrel, with chain-of-custody documentation and recorded operating parameters. The resulting specimen(s) may be examined using microscopy and/or digital analysis to compare reproduced striations and class characteristics.

### Example Operating Parameters (Non-Limiting)

In some embodiments, an elongated drive member is rotated at about 1 rpm to about 600 rpm, about 5 rpm to about 300 rpm, or about 10 rpm to about 120 rpm. In some embodiments, rotation rate is selected to reduce thermal effects and to reduce jerk, while maintaining reasonable test time. In some embodiments, a variable-speed drive is used to slowly start and stop advancement.

In some embodiments, a payload is advanced at an average axial rate of about 0.1 mm/s to about 200 mm/s, about 0.5 mm/s to about 50 mm/s, or about 1 mm/s to about 20 mm/s. In some embodiments, slower rates can improve toolmark fidelity for harder payloads or rough bores, while faster rates can reduce time for softer payloads or smoother bores.

In some embodiments, axial force and/or torque are monitored. For example, a torque sensor 200 or current-based torque estimation in an electric drive may be used to detect binding or obstructions. In response, the drive may stop, reverse, or reduce speed.

In some embodiments, lubrication is optionally applied to at least one of the bore, the payload, or the drive member. Lubricants may include oils, greases, dry lubricants, or water-based lubricants. In some embodiments, lubrication is minimized or excluded to avoid altering surface detail on the marking portion.

### Control, Sensors, and Data Logging (Optional)

One or more sensors may be included to monitor torque, current, axial force, displacement, and/or rotational speed. A controller may use sensor feedback to maintain a target speed or force profile, detect stalls, and/or log parameters associated with each specimen.

In some embodiments, the controller is configured to log, for each specimen, one or more of: barrel identifier, operator identifier, payload identifier, payload material, payload dimensions, drive member type, drive speed profile, estimated torque, estimated axial force, elapsed time, travel distance, and/or anomaly events (e.g., stall, reverse, speed reduction).

In some embodiments, the controller is configured to implement a closed-loop profile that (i) ramps speed at start and stop, (ii) maintains a target axial advance rate, and/or (iii) maintains a target force/torque envelope to reduce stick-slip and preserve striation detail.

### Kits, Modularity, and Caliber Adaptation

In some embodiments, the system is provided as a kit including one or more drive members of different lengths and thread pitches, one or more drive couplers (e.g., drill couplers, hand cranks, or keyed couplers), and a set of translation members (e.g., nuts, carriages, or threaded drivers).

The kit may further include caliber-specific guides and alignment components, including polymer guide (plastic guide), bushings, sleeves, stepped alignment inserts, and elastomeric centering elements such as O-rings. Replaceable inserts and pads may be provided for a barrel vise to accommodate different barrel profiles while reducing risk of external surface damage.

The kit may further include payload sets of different materials and shapes, including passenger slugs and threaded drivers, and may include expander elements (e.g., spherical ferrules, wedges, cones) of different diameters and tapers to tune radial engagement. The kit may include a collection fixture (e.g., a slug catch box) with interchangeable capture-chamber liners and with bearing components (e.g., thrust bearings, washers, jam nuts) to support the drive member.

In some embodiments, consumable payloads are provided as pre-sized caliber-specific blanks and/or as pre-threaded driver elements, individually packaged to reduce contamination and to preserve surface finish prior to use.

### Additional Embodiments, Variations, and Options

The systems and methods described herein can be implemented on assembled firearms, disassembled firearms, and/or firearm components. For example, the barrel 102 may remain attached to a firearm frame or receiver, or may be removed and placed in a fixture 170. The capture module 160 may be mounted at a muzzle end, at a breech end, or at an intermediate location, depending on firearm configuration and access.

In some embodiments, the system is configured to operate in a “pull” mode (advancing a payload toward the drive mechanism or toward a capture module) or a “push” mode (advancing a payload away from the drive mechanism). In some embodiments, the elongated drive member 110 extends through the bore and provides access on both ends, enabling different drive and capture configurations.

In some embodiments, the system is configured to operate with conventional rifling or polygonal rifling. For polygonal rifling, the marking portion outer surface may be selected to conform to polygonal land geometry and to record corresponding striations.

In some embodiments, the capture module 160 includes evidence-preserving features such as a sealed capsule that receives the payload and that can be labeled without removing the payload from the capsule. In some embodiments, the capsule includes a transparent window for visual confirmation.

In some embodiments, a single operation produces multiple specimens, such as a driver specimen and a passenger specimen, or multiple passenger specimens separated by spacers. In some embodiments, specimens are generated at different barrel conditions (e.g., clean vs fouled) to study variability.

### Non-limiting Advantages

Controlled and repeatable non-firing generation of barrel-imparted toolmarks on a payload.

Reduced reliance on percussive forcing and associated slip-stick behavior.

Anti-binding payload architectures that reduce seizing on a drive member during radial compression in the bore.

Muzzle-side support and thrust-bearing structures that reduce friction and improve smoothness.

Multiple specimen options (e.g., driver and passenger) from a single operation.

### INDUSTRIAL APPLICABILITY

The systems, payloads, and methods described herein are useful in forensic laboratories, law enforcement agencies, research institutions, and training environments to generate projectile surrogate specimens bearing rifling-origin toolmarks without test firing. The specimens can be evaluated using comparison microscopy, 3D surface topography measurement, virtual comparison microscopy, and/or other forensic imaging techniques.

### Concluding Statements

The foregoing description illustrates and describes various embodiments. As various changes could be made in the above constructions, products, and methods without departing from the scope of the invention, it is intended that all matter contained in the above description or shown in the accompanying drawings shall be interpreted as illustrative and not in a limiting sense.

It should be understood that the features described in connection with any one embodiment may be combined with the features described in connection with other embodiments, except where such combination is not feasible.

### REFERENCE NUMERALS (NON-LIMITING)

100 system
102 barrel
104 bore
106 rifling
110 elongated drive member
112 threaded portion
114 unthreaded portion
116 drive interface
118 protective sleeve
120 payload
122 marking portion
124 drive portion
126 clearance bore
128 threaded bore portion
130 deformation-inducing element
136 through-bore
140 drive nut/locknut
150 free-rotation assembly
160 capture module
162 aperture
164 bearing assembly
166 jam nuts
168 alignment feature/insert
170 fixture
180 insertion guide/protective interface
182 O-ring
184 polymer guide sleeve
190 passenger payload
192 driver
194 spring/compliant element
200 sensor
210 drive mechanism

What is claimed is:

1. A system for reproducing rifling-origin toolmarks without firing a firearm, comprising: an elongated drive member configured to extend along a bore axis of a rifled barrel; a payload configured to traverse a bore of the rifled barrel and to receive striated toolmarks imparted by rifling of the rifled barrel; a translation member configured to couple axial force from the elongated drive member to the payload; and a drive mechanism operably coupled to the elongated drive member to provide controlled motion to advance the payload through the bore, wherein the payload is permitted to rotate about the bore axis as guided by engagement with the rifling while advancing through the bore.

2. The system of claim 1, further comprising a capture module positionable adjacent an end of the rifled barrel and defining a capture volume configured to receive the payload after the payload exits the rifled barrel.

3. The system of claim 2, wherein the capture module comprises a bearing assembly configured to react axial load from the elongated drive member while permitting rotation of at least a portion of the elongated drive member.

4. The system of claim 3, wherein the bearing assembly comprises a thrust bearing.

5. The system of claim 2, wherein the capture module comprises an alignment insert configured to center the elongated drive member relative to an aperture of the capture module.

6. The system of claim 1, wherein the translation member comprises a drive nut positioned on a threaded portion of the elongated drive member and configured to apply axial force to the payload.

7. The system of claim 6, further comprising a free-rotation assembly positioned to transmit axial load from the drive nut to the payload while permitting relative rotation.

8. The system of claim 6, further comprising a deformation-inducing element positioned between the drive nut and the payload and configured to promote outward deformation of the payload.

9. The system of claim 1, wherein the payload comprises a marking portion and a drive portion, the marking portion having an outer diameter configured to engage the rifling and the drive portion having an outer diameter smaller than the bore to reduce contact with the rifled barrel.

10. The system of claim 9, wherein the marking portion defines a clearance bore having an inner diameter greater than an outer diameter of the elongated drive member.

11. The system of claim 9, wherein the drive portion defines a threaded bore portion configured to engage a threaded portion of the elongated drive member.

12. The system of claim 1, wherein the translation member comprises a threaded driver engaged with a threaded portion of the elongated drive member, a passenger payload positioned forward of the threaded driver, and a deformation-inducing element positioned between the threaded driver and the passenger payload.

13. The system of claim 12, wherein the deformation-inducing element defines a through-bore configured to allow passage of the elongated drive member.

14. The system of claim 1, further comprising an insertion guide including a polymer sleeve and an elastomeric O-ring configured to center and protect the elongated drive member during insertion into the rifled barrel.

15. The system of claim 1, further comprising a sensor configured to measure at least one operational parameter selected from torque, rotational speed, axial force, displacement, or a combination thereof.

16. A method of generating a toolmark specimen without firing a firearm, comprising: positioning an elongated drive member generally coaxially with a rifled bore of a barrel; coupling a deformable payload to the elongated drive member via a translation member; operating a drive mechanism to provide controlled mechanical motion that advances the payload through the rifled bore; permitting the payload to rotate about a bore axis as guided by rifling while advancing; and capturing the payload after traversal through the rifled bore for forensic examination.

17. The method of claim 16, wherein coupling the payload to the elongated drive member comprises engaging a threaded bore portion of the payload with a threaded portion of the elongated drive member while providing a clearance bore at a marking portion of the payload to reduce binding.

18. The method of claim 16, wherein capturing the payload comprises receiving the payload in a capture module positioned at either end of the barrel, the capture module including a bearing assembly and an alignment feature configured to maintain coaxial alignment of the elongated drive member.

19. A consumable payload for reproducing rifling-origin toolmarks without firing, the consumable payload comprising: a marking portion configured to engage rifling of a barrel and to receive striated toolmarks; and a drive portion configured to couple to an elongated drive member, wherein the marking portion defines a clearance bore and the drive portion defines a threaded bore portion.

20. The consumable payload of claim 19, wherein at least one of (i) the marking portion and the drive portion comprise different outer diameters, or (ii) the marking portion and the drive portion comprise different materials.
